(19) United States
(12) Patent Application Publication
(10) Pub. No.: US 2009/0060411 A1
(43) Pub. Date: Mar. 5, 2009

(54) PLANAR MAGNETIZATION LATCHING IN MAGNETO-OPTIC FILMS

(75) Inventors: Miguel Levy, Chassell, MI (US); Xiaoyue Huang, Houghton, MI (US); Raghav Vanga, Houghton, MI (US); Ziyou Zhou, Houghton, MI (US)

Correspondence Address: MICHAEL BEST & FRIEDRICH LLP, 100 E WISCONSIN AVENUE, Suite 3300, MILWAUKEE, WI, 53202, US

(73) Assignee: MICHIGAN TECHNOLOGICAL UNIVERSITY, Houghton, MI (US)

(21) Appl. No.: 11/850,373

(22) Filed: Sep. 5, 2007

(51) Int. Cl. G02F 1/095; G02F 1/09

(52) U.S. Cl. 385/6; 359/280

(57) ABSTRACT

A latching magnetic structure in the resonant cavity of magneto-photonic crystal films with in-plane magnetization. Also disclosed is a method for the fabrication and observation of a latching magnetic structure.

### STATEMENT REGARDING FEDERALLY SPONSORED RESEARCH OR DEVELOPMENT

This invention was made with United States government support under the National Science Foundation (“NSF”) awarded by grant number ECS 0520814. The United States government has certain rights in this invention.

### BACKGROUND

The invention relates to magnetic thin film materials, particularly magnetic thin film materials having in-plane magnetization.

In many applications of lasers or other radiation sources, it is important to prevent reflected radiation from interacting with the source. Reflected radiation generates undesirable noise and unwanted feedback. A circuit having photonic (or optical) components (e.g., an optical switch) is an example of an application where there exists a need to isolate a source from reflected radiation.

As is known in the art, the Faraday effect in magneto-optical materials rotates the polarization of an incident beam as it passes through the material. Because of their Faraday effect, magneto-optical materials are used in non-reciprocal devices such as an isolator, i.e., a device that permits the transmission of light in only one direction. By placing an isolator near the radiation source in the path of propagating light, the isolator allows the emitted light to pass through. Any reflected light from the optical circuit is not permitted to pass through the isolator. Instead, the isolator blocks-out the reflected light, preventing the light from interacting with the source.

### SUMMARY

In one embodiment, the invention provides a latching magnetic structure in the resonant cavity of magneto-photonic crystal films with in-plane magnetization.

In another embodiment, the invention provides a method for the fabrication and observation of latching magnetic structures.

In another embodiment, the invention provides a magneto-optic system including a substrate, and an optical material disposed next to the substrate and allowing optical radiation to propagate through the material in a direction. The optical material includes an in-plane component of a magnetization larger than the out-of-plane component of the magnetization. The optical material further includes a strip structure having a width that is measured perpendicular relative to the propagation direction and a length that is measured in-line with the propagation direction, the length being greater than the width.

In another embodiment, the invention provides a magneto-optic system including a substrate and an optical material disposed next to the substrate. The optical material includes an in-plane component of the magnetization larger than the out-of-plane component of the magnetization. The optical material further includes a magneto-photonic crystal allowing optical radiation to propagate through the photonic crystal in a direction. The magneto-photonic crystal includes a strip having a width that is measured perpendicular relative to the propagation direction and a length that is measured in-line with propagation direction, the length being greater than the width.

In another embodiment, the invention provides a magneto-optic system including a substrate, and an optical material disposed next to the substrate. The optical material has a waveguide configured to allow optical radiation to propagate through the waveguide along its axis. The waveguide has a resonant cavity that includes a strip structure which favors a magnetization orientation in-line with the waveguide axis.

Other aspects of the invention will become apparent by consideration of the detailed description and accompanying drawings.

### BRIEF DESCRIPTION OF THE DRAWINGS

FIG. 1 illustrates a one-dimensional magneto-photonic crystal having a ridge waveguide.

FIG. 2A illustrates a one-dimensional magneto-photonic crystal having a ridge waveguide and a resonant cavity that includes a plurality of magnetic strips.

FIG. 2B illustrates a scanning-electron micrograph of the magneto-photonic crystal on the ridge waveguide and the resonant cavity with magnetic strips of FIG. 2A.

FIG. 3 illustrates a testing apparatus for testing the polarization rotation response from the magneto-photonic crystal waveguide with domain-strip structures in the cavity.

FIG. 4 is a table that includes properties of a plurality of films where magneto-photonic crystals can be fabricated.

FIG. 5A is a plot that illustrates transmittance versus wavelength for a certain magneto-photonic crystal with domain strips on a 1.73 μm thick film.

FIG. 5B is a plot that illustrates transmittance versus wavelength for another magneto-photonic crystal with domain strips on a 1.82 μm thick film.

FIG. 6A is a plot that illustrates polarization rotation hysteresis versus an applied magnetic field in a plurality of magneto-photonic crystal waveguides.

FIG. 6B is a plot that illustrates polarization rotation hysteresis versus an applied magnetic field for the magneto-photonic crystal with magnetic strips in resonant cavity used in FIG. 5B

FIG. 7 is a plot that illustrates ellipticity versus an applied magnetic field.

FIG. 8 is a micromagnetic simulation of the hysteresis loop for an eight-strip array structure with experimentally-determined hysteresis loop shown in dark diamonds in FIG. 6A.

FIG. 9 illustrates a micromagnetic simulation of the dynamic reversal flow frames in magnetization of single-domain strips positioned within the resonant cavity.

FIG. 10 is a plot that illustrates magnetization saturation fields versus film thicknesses of four samples of magneto-photonic crystals.

FIG. 11 is another plot that illustrates magnetization reversal fields versus film thicknesses of four samples of magneto-photonic crystal structures.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Magnetic bi-stability and single domain formation have been studied in planar photonic structures fabricated on iron garnet films having thicknesses of less than 2 μm. The introduction of strip-shaped single-domain rectangular features into Bragg grating-defined micro-cavities results in magnetically bi-stable structures displaying discrete jumps in their optical hysteresis. An enhanced saturation field is observed and analyzed by micromagnetic simulation. As used herein, a saturation field is the minimum magnetic field required to reverse the magnetization in the resonant cavity of a magneto-photonic crystal. For sectioned cavities this corresponds to the minimum field required to reverse the magnetization of all the single-domain strips in the cavity. The effect of domain closure loops on the magneto-photonic response near resonance was studied and found to impact negatively on the reversal mechanism of these magneto-photonic crystals. Magnetization reversal in the strips was found to depend on film thickness and to be assisted by domain closure loops linking separate domain strips in the resonant cavity.

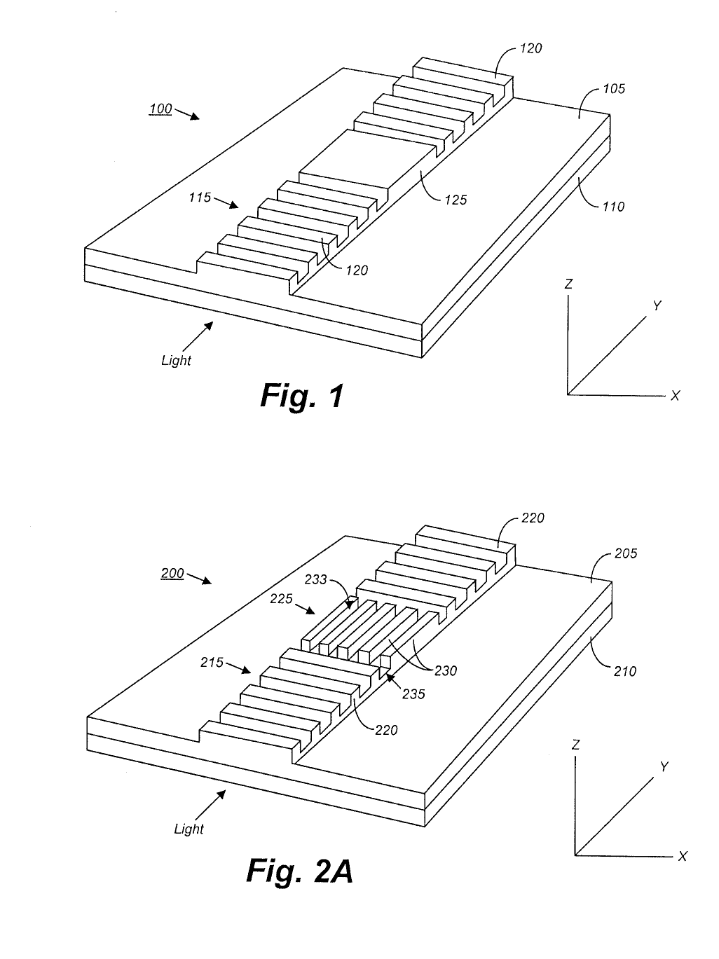

The introduction of single-domain structures into the resonant micro-cavity of a magneto-photonic crystal is advantageous because the resonant response of the photonic crystal is localized in the micro-cavity, and therefore, the magnetic properties of this cavity exert a strong influence on the overall optical response of the device. Hence it is possible to have a significant impact of the performance of the device by modifying the magneto-optic structure in a very small or reduced geometrical region on the order of microns through the introduction of single-domain formations into the resonant micro-cavity of the magneto-photonic crystal. FIG. 1 illustrates a photonic or optic crystal 100. In some embodiments, the crystal 100 includes magnetic properties, and, as such, is known as a magneto-photonic crystal 100. By magneto-photonic crystal is meant a photonic band-gap structure composed of at least one magnetic material.

In the embodiment shown in FIG. 1, the magneto-photonic crystal 100 is a planar Bragg grating waveguide etched in magneto-optical material 105 which is deposited or grown on a substrate material 110. In some embodiments, at least a portion of the optical material 105 is composed of yttrium iron garnet (“YIG”) film. In other embodiments, however, the optical film layer 105 can include a variety of other materials that exhibit in-plane magnetization and high magnetic remanence (e.g., bismuth-substituted YIG (“Bi:YIG”), bismuth-substituted dysprosium iron garnet (“Bi:DyIG”), cerium-substituted YIG (“Ce:YIG”), ytterbium iron garnet (“YbIG”), bismuth-substituted YbIG (“Bi:YbIG”), or other various rare-earth iron garnets). In some embodiments, the substrate layer 110 is composed of gadolinium gallium garnet (“GGG”). In other embodiments, the substrate layer 110 may be composed of a variety of other non-magnetic dielectric materials (e.g., silicon dioxide (“SiO₂”), tantalum oxide (“Ta₂O₅”), samarium scandium gallium garnet (SSGG), calcium, manganese, and zirconium doped GGG (CMZ:GGG), etc.). In the embodiment shown in FIG. 1, the optical material 105 is disposed next to the substrate layer 110 on one side, and exposed to air on the other. However, in other embodiments, the magneto-photonic crystal 100 may be enclosed in a cladding material, or disposed on and/or in another device (e.g., a microchip), as described in greater detail below.

The optical material 105 includes a ridge waveguide 115 having a plurality of gratings 120, as well as a resonant cavity or defect 125. Generally, a light source is positioned at one end of the ridge waveguide 115 such that optical radiation (e.g., light waves or photons) from the light source propagate from one end of the ridge waveguide 115 to the other (e.g., along the y-axis). The gratings 120, also known as Bragg gratings, are structures which reflect particular wavelengths of the optical radiation and transmit other wavelengths of optical radiation. This is achieved by adding a periodic variation to the refractive index of the optical material 105 or by patterning a periodically varying surface relief on the optical material 105. The gratings 120 can therefore be used as an in-line optical filter to block certain wavelengths of optical radiation (e.g., an optical radiation wavelength-specific reflector). In the embodiment shown in FIG. 1, the gratings 120 are generally rectangular or square shaped. However, in other embodiments, the gratings may be embodied using a variety of structures which add the desired periodicity to the refractive index of the optical material 105 or to the effective index of the waveguide modes propagating in the waveguide. As optical radiation propagates through the ridge waveguide 115 and the gratings 120, the optical radiation encounters the resonant cavity 125. When a wave that is resonant with the length of the resonant cavity 125 enters, photons are temporarily trapped within the resonant cavity 125, generally with relatively low loss, depending on the material characteristics of the film and the geometrical characteristics of the waveguide, such as surface roughness. As additional waves enter the cavity, the waves combine with and reinforce the resonant (standing) wave, thereby increasing the intensity of the resonant wave. In some embodiments, as described in greater detail below, the resonant cavity 125 can be utilized to enhance certain effects, such as the polarization rotation of the resonant wave, or to induce a wavelength-dependent polarization rotation by spectral decomposition of the incident wave by the photonic crystal. As used herein, polarization rotation refers to the angle between the semi-major axis of the polarization of light as it enters a magneto-photonic crystal and the semi-major axis of the polarization ellipse exiting the same magneto-photonic crystal.

In some embodiments, when light is transmitted though a layer of magneto-optic material, a resulting polarization rotation is created. Some magneto-optic polarization rotators require a constant magnetic source to effectively rotate the polarization of light. Others may maintain their magnetic characteristics after being altered by the presence of a quasi-static magnetic field. In some embodiments, the magneto-photonic crystal 200 may be used in an optical switch or an optical isolator. The use of a bi-stable magnetic structure in the micro-cavity is advantageous for both applications as it enhances the magnetic stability of the device. Alternative applications of the magneto-photonic crystal 100 should be appreciated by one of ordinary skill in the art.

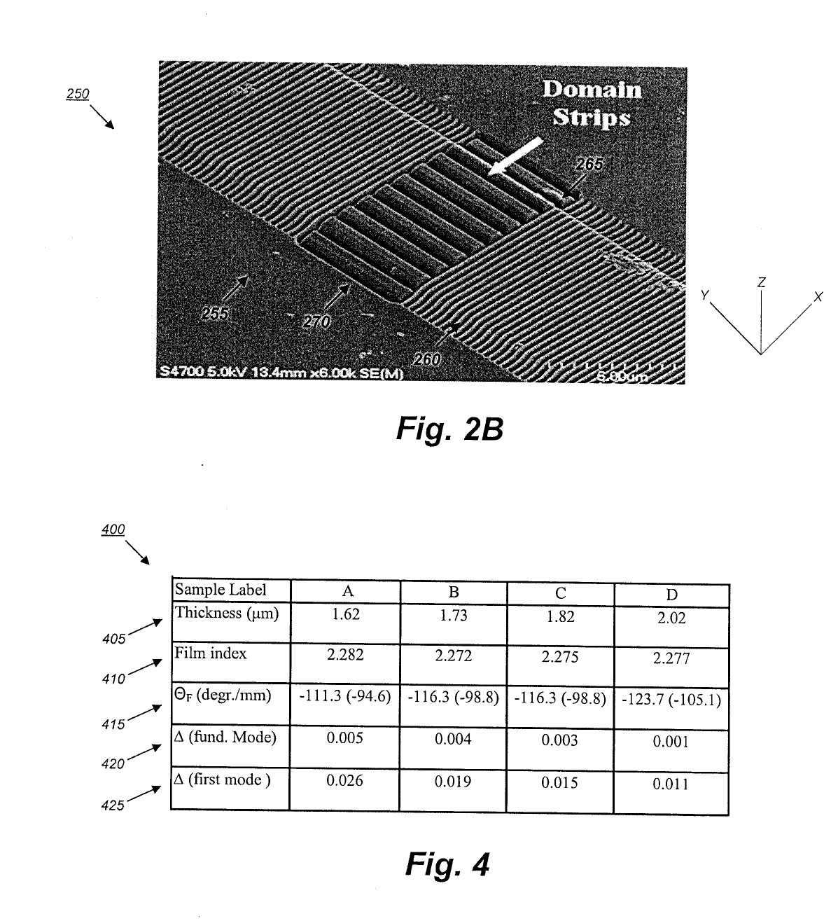

FIG. 2A illustrates a magneto-photonic crystal 200. Similar to the crystal shown in FIG. 1, the magneto-photonic crystal 200 shown in FIG. 2A is a planar Bragg grating waveguide etched in magneto-optical material 205, which is deposited or grown on a substrate material 210. In some embodiments, at least a portion of the optical material 205 is composed of yttrium iron garnet (“YIG”) film. The optical material 205 includes a ridge waveguide 215 having a plurality of gratings 220, as well as a resonant cavity or defect 225. However, in the embodiment shown in FIG. 2, the resonant cavity 225 includes a plurality of strips 230. The strips 230 are elongated, such that the length (i.e., as measured along the “y” axis) of a single strip 230 is approximately 12-15 times the width (i.e., as measured along the “x” axis) of a single strip 230. One or more of the strips 230 can form a strip structure making up the resonant cavity 225. In other embodiments, an alternative length to width ratio of the strips 230 may be implemented, as described in greater detail below.

The strips 230 are separated from one another by grooves 233. The grooves extend substantially through the thickness (i.e., as measured along the “z” axis) of the optical material 205, but do not fully detach the strips 230 from one another (e.g., the grooves 233 do not extend all the way to the substrate layer 210). In other implementations the strips can extend all the way to the substrate layer. The strips 230 can be separated from the gratings 220 by trenches 235. The width and depth of grooves 233, as well as the width and depth of the trench 235 may alter the magnetic and/or the optical characteristics of the crystal 200.

Dividing the resonant cavity 225 into the elongated strips 230 aids in creating magnetically bi-stable strips (e.g., magnetically stable in two directions) within the resonant cavity 225 that exhibit an enhanced saturation field (e.g., resistance to movement of in-plane domain walls and/or rotations in domain magnetizations) after excitation by a magnetic field. For example, the geometrical confinement of the magnetic particles within the resonant cavity 225 reduces multi-domain formation. Such coercivity or maintenance of magnetic saturation after exposure to, and removal from, a magnetic field can be referred to as latching. Some traditional polarization rotators (e.g., Faraday rotators) require a permanent magnet to supply the magnetic bias needed for polarization of optical radiation (i.e., photons, light waves, etc.). However, the need for a permanent magnetic source may be eliminated if the resonant cavity 225 is latching, and resists domain change from various external magnetic fields. By eliminating a permanent magnetic source (e.g., a ferrous magnet or Helmholtz coils), small scale applications of the magneto-photonic crystal 200 (e.g., fabricated on a microchip) or planar magnetic devices (e.g. a magnetic field waveguide sensor) are enabled.

FIG. 2B illustrates a scanning-electron micrograph of a magneto-photonic crystal 250. More specifically, the scanning-electron micrograph of FIG. 2B is a top view the magneto-photonic crystal 250, which is composed of a liquid-phase epitaxial (“LPE”) (Bi,Lu,Nd)₃(Fe,Ga,Al)₅O₁₂ film grown on (111)-oriented Gd₃Ga₅O₁₂ (GGG) substrate. The film is in-plane magnetized (magnetized in the x-y plane) and has a lattice mismatch with the substrate (a_{substrate}-a^{p}_{film}, where a^{p}_{film} is the lattice parameter of the film in the perpendicular or “x” direction) ranging from −0.013 angstrom to −0.025 angstrom.

The magneto-photonic crystal 250 includes a ridge waveguide 255 having gratings 260, as well as a plurality of strips 265 which define a resonant cavity 270. In the embodiment shown in FIG. 2B, the gratings 260 are approximately 200 micrometers (μm) long, and are separated by 170 nanometer (nm) wide, 600 nm deep grooved gratings. The strips 265 are approximately 0.6 μm wide and 9.2 μm long, and are separated by 400 nm wide, 1.2 μm deep grooves. The ridge waveguide 255 can be formed using photolithography and plasma etching methods. For example, a Nabity Nanopattern Generation System (NPGS) can be used to control a gallium-ion beam in a focused ion beam column to mill the grooves in the ridge waveguide 255. Additionally, a ten second phosphoric acid etch can be implemented after milling to clear debris from the grooves. In other embodiments, the ridge waveguide 255 may be formed using alternative techniques (e.g. electron-beam-lithography), as should be appreciated by one of ordinary skill in the art.

The gratings 260 have a grating period of 348 nm, which corresponds to fundamental and first order mode stop bands (e.g., wavelength ranges in which optical radiation is reflected) in the 1500 nm to 1580 nm wavelength range. In the embodiment shown in FIG. 2B, eight strips 265 are included in the resonant cavity, and are positioned with the long axes of the strips 265 parallel to the propagation axis of the ridge waveguide 255. However, in other embodiments, as described below, more or fewer strips 265 may be implemented within the resonant cavity (e.g., 3, 6, 12, 17, etc.). In some embodiments, the strips 265 are positioned in the center of the ridge waveguide 255, approximately equidistant from the beginning and the end of the ridge waveguide 255. Additionally, in some embodiments, the strips 265 are approximately one quarter wave plus 26 one half wavelengths in length. Generally, a cavity length of one quarter wavelength is sufficient to sustain a resonant or standing wave. However, the added cavity length beyond a quarter-wave serves to create enough space for the strips 265 to include a substantial length-to-width ratio (e.g., 12:1, 15:1, etc.). Therefore in other embodiments, the number of half wavelengths can be varied as long as a substantial length-to-width and length-to-thickness ratio is maintained. By elongating the strips 265, a magnetization orientation along the optical propagation direction can be maintained. For example, the magnetic particles of the film are geometrically confined such that the threat of multi-domain formations within each strip caused by external magnetic biases can be reduced and/or avoided.

During use, optical radiation is propagated through the magneto-photonic crystal 250. Relative to the perspective of the top view shown in FIG. 2B, optical radiation propagates through the ridge waveguide 255 from the lower right corner to the upper left corner. The optical field distribution in the resonant cavity 270 encompasses the entire array of strips 265. For example, evanescent tails bridge the 400 nm gaps between the strips 265. In some embodiments, a greater amount of optical radiation may be present in the center most strips 265.

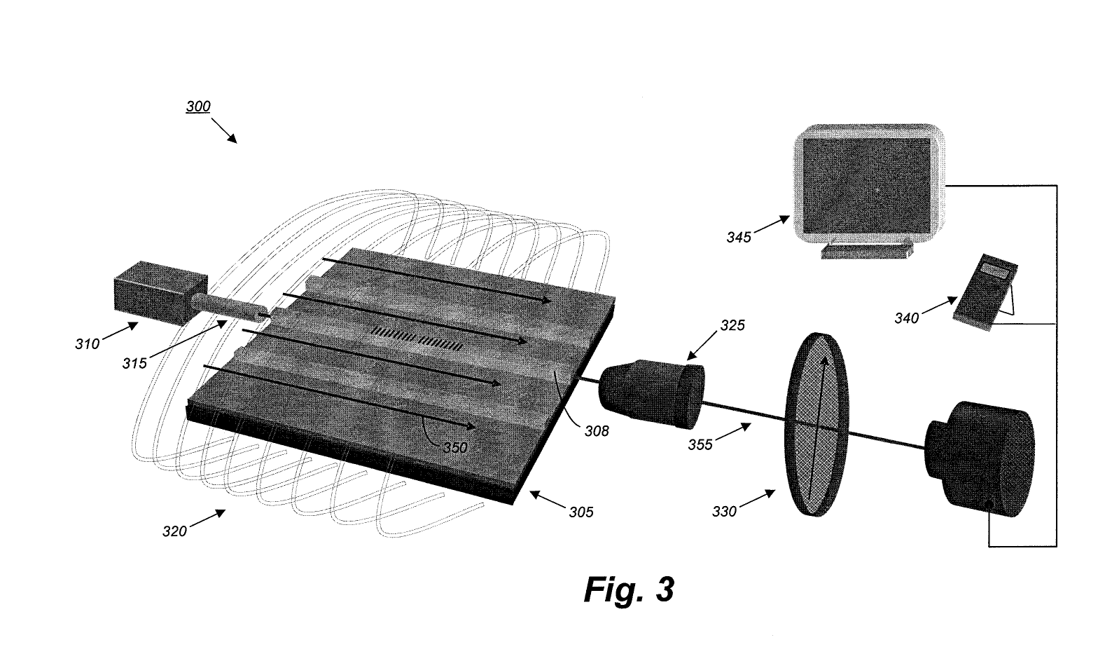

Sample facets can be fashioned on the relative ends of the ridge waveguide 255 to allow for coupling to an optic radiation source. For example, in some embodiments, as described with respect to FIG. 3, light from a lensed fiber is end-fire coupled to the magneto-photonic crystal 250. In other embodiments, only the cavity 270 with strips 265 may be prepared to be installed in an alternative application with direct light source radiation, such as on a microchip.

FIG. 3 illustrates an embodiment of a testing system 300. The testing system 300 can be used to test optical characteristics and performance of magneto-photonic crystals, such as the magneto-photonic crystals shown in FIGS. 1-2B. In the embodiment shown in FIG. 3, the testing system 300 is used to test a magneto-photonic crystal planar waveguide 305 having a plurality of ridge waveguides 308. In some embodiments, the ridge waveguides 308 may include a variety of gratings, one or more resonant cavities, and/or other patterned features.

In the embodiment shown in FIG. 3, the testing system includes a light source 310, a fiber 315, a plurality of magnetic coils 320, an objective microscope 325, and a polarizer 330. Additionally, the testing system 300 includes a beam splitter 335, a photo detector 340, and a monitor 345. In other embodiments, the testing system 300 may include more or fewer components than those shown, as required by the characteristics being tested. The light source 310 is a tunable laser capable of producing a laser beam having a wavelength between approximately 1480 nm and 1580 nm. Additionally, the light source 310 can be tuned to produce a beam having transverse electric (“TE”) (e.g., horizontal) polarization having approximately 0.3 milliwatts (“mW”) of power. The fiber 315 is coupled to the light source 310, and positioned at a relative end of one the ridge waveguides 308. The magnetic coils 320 produce a magnetic field along the length of the crystal structure 305 and parallel to the axis of optical propagation of the ridge waveguides 308, as indicated by magnetic field arrows 350. In some embodiments, the magnetic coils 320 are water cooled.

The objective microscope 325 is positioned at an end of the crystal structure 305 opposite that of the light source 310 and fiber 315. In some embodiments, the objective microscope 325 magnifies a beam exiting the crystal structure 305 by approximately 10 times, although microscopes having varying magnification powers may be used. The polarizer 330 is positioned adjacent to the objective microscope 325, and can be used to analyze the polarization of a light beam from the objective microscope 325. In some embodiments, the polarizer 330 is a motorized rotating Glan-Thompson polarizer with sub-degree precision. The beam from the polarizer 330 is recorded by the photo detector 340 having nanowatt (“nW”) resolution. The beam spot shape and intensity are monitored using the monitor 345.

During use, the light source 310 and fiber 315 are positioned such that a beam 355 created by the light source 310 is forced to propagate through one of the ridge waveguides 308. By passing through the ridge waveguide 308, the beam 355, which was originally TE polarized, is rotated due to the magnetic properties associated with magneto-photonic crystal 305. For example, in some embodiments, the ridge waveguide 308 includes a resonant cavity having single-domain strips (e.g., the strips 265 of FIG. 2B) which significantly rotate the polarization of the beam 355. In some embodiments, this rotation can be referred to as Faraday rotation. However, due to an admixture of circular and linear birefringence inherent to the magneto-photonic crystal 305 (described below), the beam exiting the magneto-photonic crystal 305 may be elliptically polarized. Accordingly, the term polarization rotation may be used to generally refer to the rotation of polarization associated with the ridge waveguide 308 and resonant cavity.

The polarization-rotated and elliptically polarized beam 355 is magnified by the objective microscope 325 after exiting the magneto-photonic crystal 305. The beam 355 then passes through the polarizer 330, which, in conjunction with the photo detector 340, can be used to measure the polarization rotation angle. The angle of polarization rotation is measured with respect to the direction of the semi-major axis of the elliptical output polarization relative to the input polarization (e.g., horizontal, or TE polarization). In the embodiment shown, this angle can be determined within approximately ±2 degrees of experimental uncertainty. The shape and intensity of the beam 355 that has passed through the polarizer 330 can be evaluated using the monitor 345.

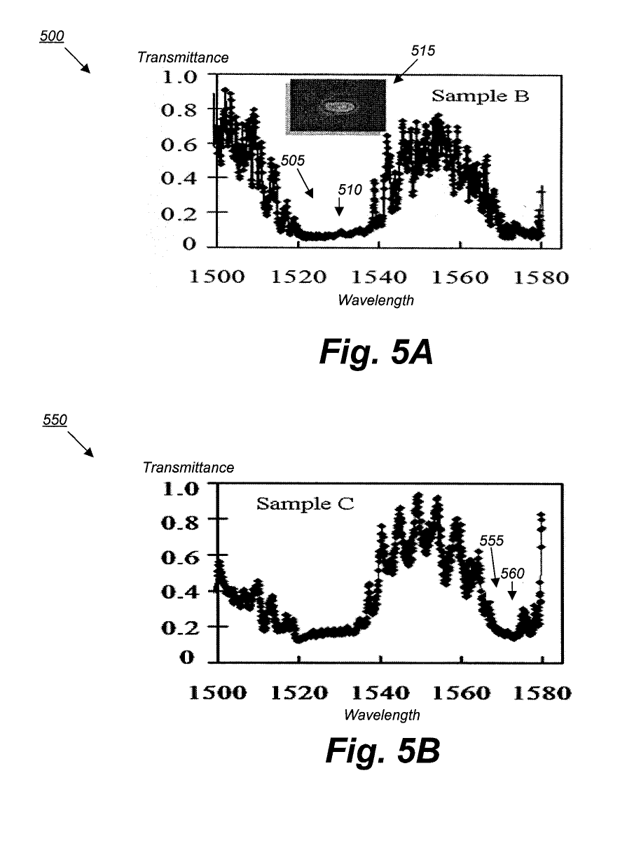

FIG. 4 is a table 400 that includes data from four samples (labeled Sample A, Sample B, Sample C, and Sample D) onto which magneto-photonic crystal waveguides were patterned. The magneto-photonic crystals in samples A-D included in the table 400 can be prepared using the methods described with respect to FIG. 2B (e.g., an optical film that is grown on a substrate and prepared by photolithography and plasma etching methods). As such, the magneto-photonic crystals in samples A-D included in the table 400 generally include a grating and a resonant cavity having single-domain strips. The table 400 includes data such as film thickness 405, film index 410, polarization rotation angle 415, linear birefringence corresponding to a fundamental mode 420, and linear birefringence corresponding to a fist mode 425. Additionally, as described in greater detail with respect to FIGS. 5A-7, data acquired through testing the samples A-D can be represented graphically (e.g., using plots).

The film thickness 405 of the samples is varied from one sample to another, with sample A having the thinnest film at approximately 1.62 μm, and sample D having the thickest film at approximately 2.02 μm. The film indices 410 of the samples refer to the material (not modal) index of the films, as measured for TE mode inputs. In some embodiments, the film indices are measured using a prism coupler on a slab. Linear birefringence (Δ) can be defined as the difference between modal refractive indices for transverse electric (TE) and transverse magnetic (TM) modes of the films. The presence of linear birefringence leads to elliptical polarization (described above) in the magneto-photonic crystal samples A-D. Accordingly, the polarization rotation angle (Θ_{F}) is the referential Faraday rotation per unit length as measured perpendicular to the film samples A-D to avoid linear birefringence induced distortions in the measurements. In some embodiments, the polarization rotation angle measurements are tested and recorded using a wavelength of 1300 nm, and extrapolated to 1530 nm (e.g., assuming a 1/λ− dependence in the specific Faraday rotation).

The magneto-photonic crystals in samples similar to the samples A-D (e.g., similar thicknesses, refractive indices, etc), but which lack domain strips within the resonant cavity can also be prepared to provide a comparison for the samples A-D that include domain strips. For example, optical radiation losses associated with the single-domain strips can be evaluated by testing both sets of samples. Generally, when tested, the samples A-D exhibit an excess optical radiation loss of approximately 3 dB, relative to waveguides without domain strips. Additionally, net insertion losses encompassing absorption and scattering are estimated at 6 to 7 dB at 1550 nm.

The magneto-photonic crystals in samples A-D each include two stop-bands corresponding to fundamental waveguide mode and first order waveguide mode coupling through backscattering (e.g., reflected optical radiation). Exemplary plots of these stop bands can be seen in FIG. 5A (e.g., Sample B) and FIG. 5B (Sample C), as described in greater detail below. The optical radiation that is propagated through the samples A-D in the forward direction couples primarily (e.g., approximately 90% of the total power that is propagated) to the fundamental mode of the waveguide. The grating condition, with respect to the samples A-D included in table 400, is defined by equation (1) below:

λ=Λ(n_{f}+n_{b}) (1)

where λ is the optical wavelength of the optical radiation in a vacuum, Λ is the grating period, and n_{f} and n_{b} are the modal effective indices of the forward and backward propagating beams, respectively. The polarization rotation is highly suppressed outside of the stop bands in each of the samples due to the presence of linear birefringence. However, significant rotations occur in the stop bands near resonance, as well as near the stop band edges as a result of photon trapping or as a result of wave-vector splitting between Bloch modes of opposite helicity in the crystals. A spectral decomposition into differently polarized Bloch modes by the magneto-photonic crystal will then result in a wavelength-dependent rotation of the output polarization relative to that of the polarization state of the input light.

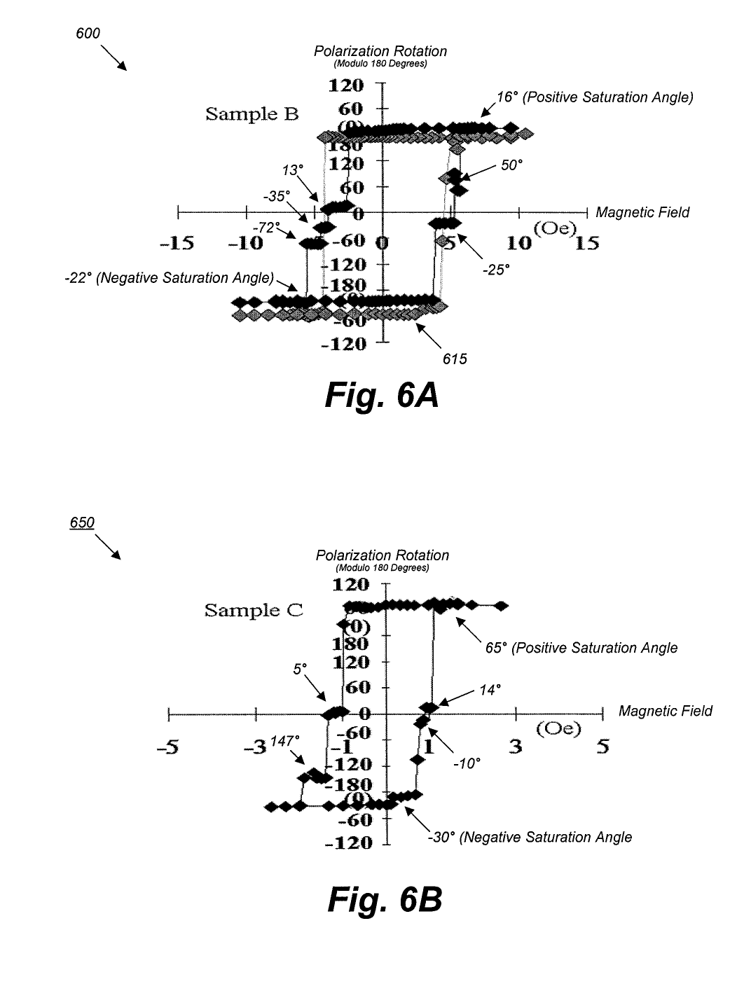

In addition to significant polarization rotations, discrete jumps in the magneto-photonic hysteresis loops are found in the stop bands for samples A-D having the single-domain strips within the resonant cavity. Exemplary plots of the hysteresis spectra can be seen in FIG. 6A (Sample B) and FIG. 6B (Sample C), as described in greater detail below. Samples that do not include single-domain strips also do not generally exhibit discrete jumps in the magneto-photonic hysteresis loops.

FIGS. 5A-7 include plots which graphically illustrate tested properties and/or characteristics of the samples A-D shown in FIG. 4. For example, FIGS. 5A and 5B include plots 500 and 550, respectively that illustrate a relationship between optical radiation transmittance and optical radiation wavelength in magneto-photonic crystals having a resonant cavity with single-domain strips. More specifically, FIG. 5A illustrates the relationship between optical radiation transmittance and optical radiation wavelength for sample B (see FIG. 4), while FIG. 5B illustrates the same relationship for sample C.

As shown in FIG. 5A, sample B includes a 27 nm wide first order mode stop band 505 from approximately 1513 nm to 1540 nm. The average transmission inside the stop band 505 is approximately −11 decibels (“dB”) when compared to the transmission outside the stop band 505. A small transmission peak 510 is present within the stop band 505 at approximately 1530 nm. The intensity of the transmission peak 510 is relatively low due to strong optical radiation confinement within the grating of sample B, as well as optical loss from the grooves that separate the domain strips of sample B, as shown in an image 515 of the spot shape and intensity.

As shown in FIG. 5B, sample C includes a fundamental mode stop band 555 from approximately 1565 nm to 1580 nm. A small transmission peak 560 is present at approximately 1575.2 nm. When measured, the stop band 555 has an average intensity of approximately 3 μW. Additionally, a transmission intensity reduction of approximately −8 dB is present within the stop band 555, relative to the out of band transmission intensity.

FIGS. 6A and 6B include plots 600 and 650, respectively, that illustrate magnetic hysteresis loops (e.g., applied magnetic field versus polarization rotation) for magneto-photonic crystals having a resonant cavity with domain strips. More specifically, FIG. 6A illustrates a polarization rotation hysteresis loop 605 (dark diamonds) for fundamental to first order mode backscattering associated with sample B, while FIG. 6B illustrates a polarization rotation hysteresis loop 655 for fundamental to fundamental mode backscattering associated with sample C. As shown in both FIGS. 6A and 6B, polarization rotations of larger than 45 degrees are present in both samples B and C. The magnitude of the polarization rotations are shown in modulo 180 degrees, due to limitations associated with equipment used to conduct the tests. For example, 180 degree shifts are graphically inserted into the plots by shifting the origin, which aids in illustrating rotational changes with increasing and decreasing magnetic field strength.

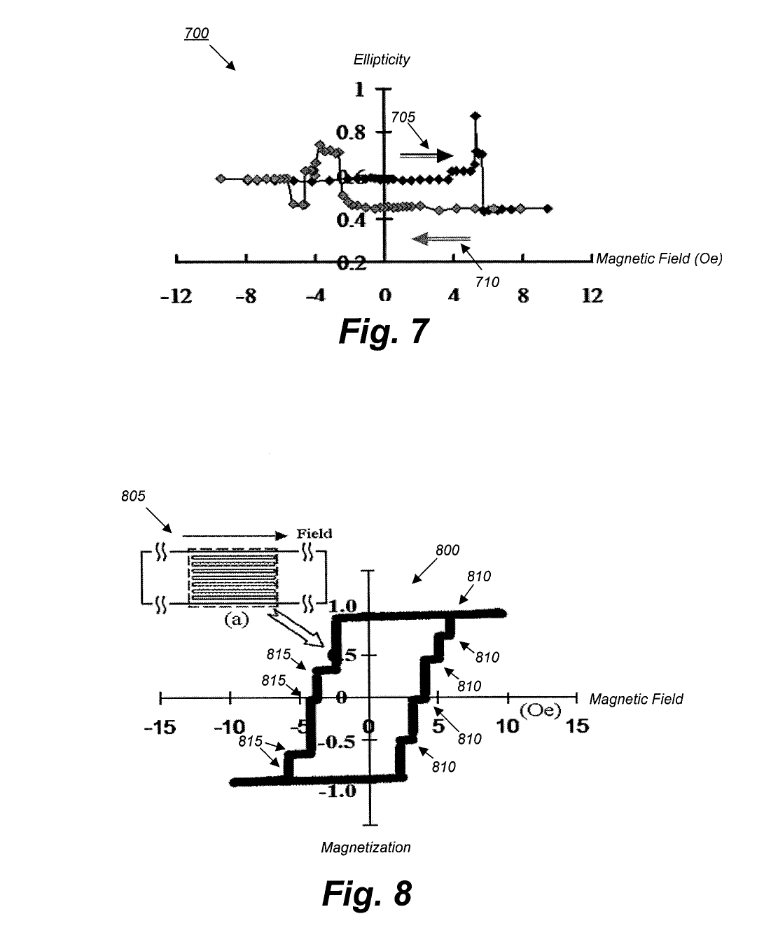

As shown in FIG. 6A, the hysteresis loop 605 associated with sample B includes seven discrete steps. These steps represent a change in magnetization orientation of one or more of the domain strips included in the resonant cavity of the sample. For example, as a positive magnetic field is applied, the domain strips become magnetically aligned in the positive direction. After magnetic saturation, all of the domain strips are magnetically aligned in a single direction. Upon the magnetic field being reversed, the domain strips begin to reverse or “flip” their magnetization alignment, as indicated by the discrete steps in the negative direction. The hysteresis loop 605 includes seven steps, with a step at 16° (mod 180°) (positive saturation angle), 13° (mod 180°), −35° (mod 180°), −72° (mod 180°), −22° (mod 180°) (negative saturation angle), −25° (mod 180°) and 500 (mod 180°). Under fully saturated magnetic field conditions, the output radiation intensity at a wavelength of 1530 nm is approximately 2.6 μW. However, each step of the hysteresis loop 605 is accompanied by a different output intensity and ellipticity (as described with respect to FIG. 7 below), thereby signaling a change in polarization state of one or more domain strips of the resonant cavity. For comparison, FIG. 6A also includes a hysteresis loop 615 for a magneto-photonic crystal waveguide that has a uniform resonant cavity (i.e., the resonant cavity does not include domain strips). The hysteresis loop 615 does not include steps that are indicative of magnetic alignment.

The hysteresis loop 655 associated with sample C, as shown in FIG. 6B, also includes discrete steps when a magnetic field is applied. For example, FIG. 6B shows six steps at 65° (mod 180°) (positive saturation angle), 5° (mod 180°), −147° (mod 180°), −30° (mod 180°) (negative saturation angle), −10° (mod 180°) and 14° (mod 180°). The experimental results plotted in FIG. 6B were gathered using an optical radiation source having a 1573 nm wavelength, which corresponds to the peak of the fundamental mode stop band (e.g., see FIG. 5B). As described in greater detail below, the film of sample C is thicker than the film of Sample B (see FIG. 4), and thus, the coercivity of sample C is less than that of sample B. For example, the magnitude of the magnetic field required to flip the magnetic orientation of the sample C is less than that of the sample B.

FIG. 7 is a plot 700 of a relationship between an applied magnetic field and the ellipticity of the polarization ellipse for sample B. For example, as described above, due to birefringence the polarization of the optical radiation being propagated through the magneto-photonic crystal is not perfectly linear. Thus, ellipticity can be defined as the amplitude ratio between semi-minor and semi-major axes of the polarization ellipse. As shown in the plot 700, the ellipticity changes when a positive magnetic field (as indicated by arrow 705) is applied to sample B. For example, as the applied magnetic field strength increases in the positive direction, the ellipticity decreases. The ellipticity also changes as a negative magnetic field (as indicated by arrow 710) is applied to the sample B. For example, as the applied magnetic field strength increases in the negative direction, the ellipticity increases,

FIGS. 8-11 generally illustrate a micro-magnetic analysis of the magnetization response of a resonant cavity having domain strips, as well as the magnetization response of the area surrounding the resonant cavity. For example, computer simulations can be used to analyze and confirm data and results gathered with respect to the tested samples (e.g., samples A-D). Computer simulations can also be used to examine the optical response and the effect of geometrical confinement of magnetic particles (e.g., confining the magnetized particles within domain strips).

As described in greater detail below, the magnetic field strength required to achieve magnetization reversal (a flip in magnetic orientation) in all the single-domain strips within a micro-cavity is modestly increased in magneto-photonic crystals having resonant cavities with domain strips, relative to magneto-photonic crystals that do not include domain strips in their resonant cavities. This indicates that magneto-photonic crystals that include domain strips are more resistant to multi-domain formation (e.g., randomly oriented magnetization) from external magnetic forces than magneto-photonic crystals that do not include domain strips. Additionally, the magneto-photonic crystals having domain strips exhibit greater saturation fields than magneto-photonic crystals that do not include domain strips. For example, when compared to magneto-photonic crystals of similar dimensions (e.g., crystals having the same thickness and overall resonant cavity dimensions) that do not have domain strips within the resonant cavity, an enhancement in saturation field of approximately 30% can be attained by sectioning the resonant cavity into an array of elongated strips. This saturation field enhancement may vary with the thickness of the magneto-photonic crystal. For example, as the thickness of the magneto-photonic crystal is increased, the saturation field enhancement may be reduced.

FIG. 8 illustrates a simulated magnetization hysteresis loop 800 of a magneto-photonic crystal having a resonant cavity with eight domain strips (e.g., as shown in the schematic top view 805). The simulated target magnetization area encompasses the resonant cavity of the magneto-photonic crystal, and measures approximately 9.2 μm long by 7.6 μm wide. As described in greater detail below, the magnetic saturation fields of the computer simulation mirrored measured values (e.g., see FIGS. 6A and 6B). In the embodiment shown in FIG. 8, the contribution to magnetization from regions external to the domain strip array has been removed, which allows for a more clear depiction of the magnetization of the domain strip array.

There are five ascending steps 810 present in the hysteresis loop 800. These steps represent domain strips becoming magnetically saturated as a positive magnetic field is applied. Alternatively, as the magnetic field is reversed, four descending steps 815 are present in the hysteresis loop 800. These steps 815 correspond to one, two, or three strips reversing their magnetization concurrently. As described above with respect to FIGS. 6A and 6B, the tested samples A-D generally exhibit a greater number of steps in their hysteresis loops. The difference in the number of steps shown in the computer simulation hysteresis loop 800 and the number of steps in the experimental hysteresis loop can be attributed to fluctuations in the number of strips that flip their magnetization simultaneously. For example, fewer steps indicate that more than one strip is flipping its magnetization orientation concurrently. The fluctuation in the number of strips that flip their magnetization concurrently is a result of the influence of the magnetic domains in the surrounding waveguide region beyond the resonant cavity. Domain closure loop formation (e.g., magnetic fields which loop from an end of a domain strip to the end of an adjacent domain strip) through the adjacent grating plays a role in the onset of magnetization reversal in the domain strips. As described with respect to FIG. 2A above, a trench separates the domain strips from the adjacent grating. As such, by varying the depth and/or width of the trench, domain closure loops can be controlled. However, drastically increasing the depth and/or width of the trench may reduce the ability to efficiently propagate optical radiation through the magneto-photonic crystal. Occasional fluctuations in the number of strips that flip their magnetization concurrently are also observed near critical magnetic threshold fields between steps. These fluctuations may be ascribed to the presence of temporary meta-stable magnetic states during the transition from one magnetic orientation to another magnetic orientation.

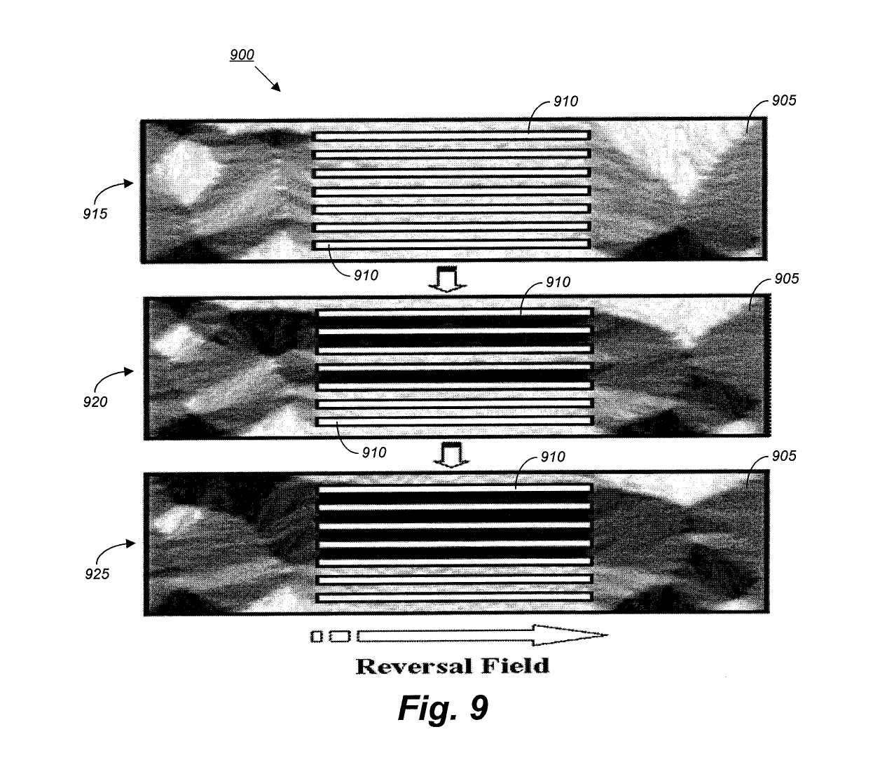

FIG. 9 illustrates a simulated dynamic magnetization reversal progression 900 of a magneto-photonic crystal 905 having a resonant cavity that includes domain strips 910. A reversal in magnetization is evident by a change in pixel color. For example, white pixels indicate a left oriented magnetization, while dark pixels correspond to a rightward orientation. Grey pixels indicate intermediate (non-horizontal) magnetic orientations. The progression 900 is split into a first stage 915, a second stage 920, and a third stage 925.

The first stage 915 illustrates the domain strips 910 being magnetically aligned and oriented to the left, while the area adjacent to the ends of the domain strips 910 is randomly oriented. The leftward magnetic orientation associated with the first stage 915 can be achieved, for example, by initially applying a magnetic field in the leftward direction until the domain strips 910 are magnetically saturated. Magnetic saturation is then maintained by geometrically confining the magnetic particles included in the magneto-photonic crystal 905.

In the second stage 920, a magnetic field is applied to the magneto-photonic crystal that is in the opposite direction of the initial orientation of the domain strips (e.g., a rightward oriented magnetic field). As the reverse magnetic field is applied to the domain strips 910, the single domain strips 910 begin to flip their magnetic orientation. This magnetization reversal can be seen by examining the change from white pixels to dark pixels. The third stage 925 shows a greater number of domain strips 910 flipping their magnetic orientation as the rightward magnetic field is continued to be applied. Magnetization reversal in the domain strips 910 is assisted by domain closure loops (described above) in the area adjacent to the ends of the domain strips 910. For example, the domain strips 910 are not fully decoupled from one another, and are connected by 600 nm deep trenches. Accordingly, as shown in FIG. 9, domain closure loops allow several of the domain strips 910 to switch their polarization simultaneously. The domain closure loops can be clearly observed in further simulation by analyzing the direction and trajectory of magnetization lines near the poles of the domain strips 910. Lateral (side to side) separations between domain strips 910 can be milled deeper (e.g., approximately 1.2 μm) than the trenches that separate the domain strips 910 at their ends, which produces a stronger lateral magnetic decoupling between the strips. However, increasing the trench depth and/or width, as described above, may affect the optical performance (e.g., transmitted power) of the magneto-photonic crystal 905.

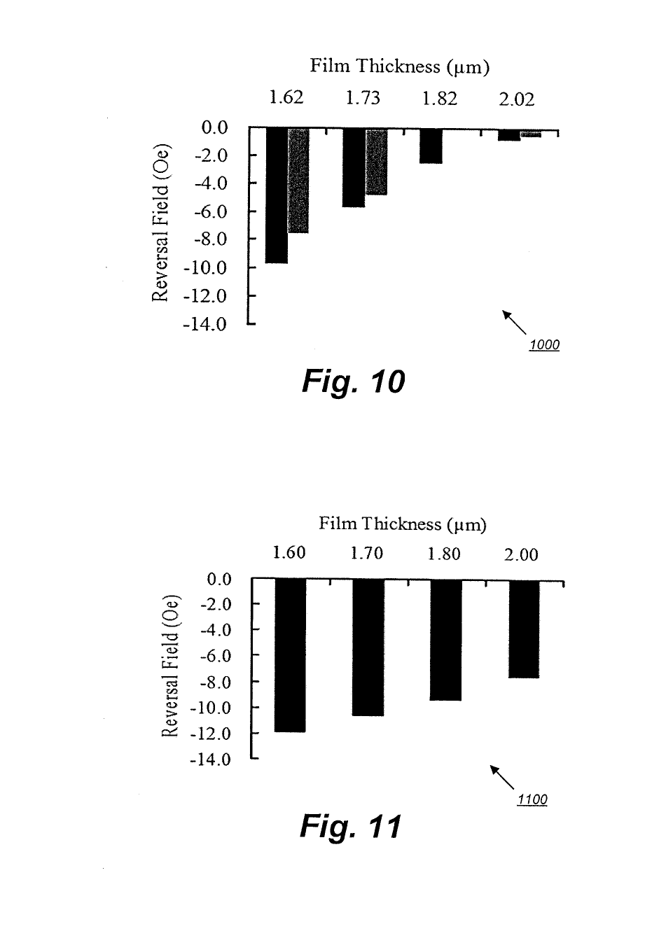

FIGS. 10 and 11 are bar charts 1000 and 1100 that illustrate a relationship between magnetic saturation field strength and magneto-photonic crystal film thickness. Additionally, to provide a basis for comparison, FIG. 10 also provides a relationship between magnetic saturation field strength and magneto-photonic crystal film thickness for samples similar to the samples A-D, but which do not include domain strips. As described in greater detail below, the magnetic saturation field required to alter the magnetization of the magneto-photonic films is greater in samples that include domain strips. Additionally, the magnetic saturation field required to alter the magnetization of the magneto-photonic films is greatest in the thinnest magneto-photonic films.

FIG. 10 provides a side-by-side comparison between the samples A-D having domain strips (as indicated by the dark bars), and the samples that lack domain strips (as indicated by the grey bars). Data was not recorded for the 1.82 μm thick sample lacking domain strips. However, the samples having domain strips exhibit a modest higher resistance to magnetization reversal relative to the samples that lack domain strips. Additionally, there is an overall trend of saturation field decrease with film thickness. For example, a thicker sample is generally more susceptible to magnetic reversal than a thinner sample. This relationship does not appear to be affected by the inclusion of domain strips. A computer simulation of the samples reveals that an alternative magnetization reversal channel (e.g., a magnetization channel normal to the optical radiation propagation direction) becomes a factor in magneto-photonic crystal films having larger thicknesses, which allows a reduction in the potential energy barrier between stable magnetic configurations.

FIG. 11 illustrates calculated saturation field strength versus film thickness for isolated individual single-domain strips. For example, rather than analyzing the reversal of an entire array of domain strips (e.g., the array of domain strips included in the samples A-D), each domain strip is individually tested. As shown in FIG. 11, the saturation fields associated with the individual single-domain strips are larger, and the thickness dependence is weaker, than the saturation fields associated with the coupled domain strip arrays. This indicates that decoupling the domain strips from each other (e.g., by increasing the trench depth and/or trench width and introducing a deeper gap at the poles of the single-domain strips) and eliminating or reducing the formation of domain closure loops may highly increase the saturation field of the domain strips. However, decoupling the domain strips may affect the optical characteristics of the magneto-photonic crystal and care should be taken to optimize the gap separating the single-domain strips at the poles in order to minimize optical losses.

Various features and embodiments of the invention are set forth in the following claims.

What is claimed is:

1. A magneto-optic system comprising:
a substrate; and
an optical material disposed next to the substrate and allowing optical radiation to propagate through the material in a direction, the optical material including an in-plane component of a magnetization larger than the out-of-plane component of the magnetization, and a strip structure having a width that is measured perpendicular relative to the propagation direction and a length that is measured in-line with the propagation direction, the length being greater than the width.

2. The system of claim 1, wherein the optical material includes a plurality of strips forming the strip structure.

3. The system of claim 2, wherein the plurality of strips includes at least two strips that are fully decoupled.

4. The system of claim 2, wherein the plurality of strips includes at least two strips nonparallel to each other.

5. The system of claim 2, wherein the plurality of strips have approximately the same configuration.

6. The system of claim 1, wherein the optical material comprises a diluted magnetic semiconductor film.

7. The system of claim 1, wherein the optical material comprises a magnetic garnet film.

8. A magneto-optic system comprising:
a substrate; and
an optical material disposed next to the substrate, the optical material including
an in-plane component of the magnetization larger than the out-of-plane component of the magnetization, and
a magneto-photonic crystal allowing optical radiation to propagate through the photonic crystal in a direction, the magneto-photonic crystal including a strip having a width that is measured perpendicular relative to the propagation direction and a length that is measured in-line with propagation direction, the length being greater than the width.

9. The system of claim 8, wherein the optical material includes a plurality of strips forming a strip structure.

10. The system of claim 9, wherein the plurality of strips includes at least two strips that are fully decoupled.

11. The system of claim 9, wherein the plurality of strips includes at least two strips nonparallel to each other.

12. The system of claim 9, wherein the plurality of strips have approximately the same configuration.

13. The system of claim 8, wherein the optical material comprises a magnetic garnet film.

14. The system of claim 8, wherein the optical material comprises a diluted magnetic semiconductor film.

15. The system of claim 8, wherein the length-to-width ratio of the strip is more than 2 to 1.

16. A magneto-optic system comprising:
a substrate; and
an optical material disposed next to the substrate and having a waveguide configured to allow optical radiation to propagate through the waveguide along its axis, the waveguide having a resonant cavity that includes a strip structure which favors a magnetization orientation in-line with the waveguide axis.

17. The system of claim 16, wherein the waveguide includes a grating positioned on either side of the resonant cavity.

18. The system of claim 16, wherein the grating is configured to include stop bands of approximately 1500 nanometers to 1580 nanometers in wavelength.

19. The system of claim 16, wherein the strip structure includes a strip.

20. The system of claim 19, wherein the strip includes a width perpendicular to the axis and a length parallel to the axis, the length being substantially greater than the width.

21. The system of claim 19, wherein the length-to-width ratio of the strip is more than 2 to 1.

22. The system of claim 16, wherein the strip structure is a latching strip structure which maintains magnetization after being excited by a magnetic field.

23. The system of claim 16, wherein the resonant cavity rotates the polarization of the optical radiation passing through the resonant cavity.

24. The system of claim 16, wherein the optical material is an iron garnet film.

25. The system of claim 16, wherein the optical material is a diluted magnetic semiconductor film.
